(19) United States
(12) Patent Application Publication
(10) Pub. No.: US 2010/0233653 A1
(43) Pub. Date: Sep. 16, 2010

(54) WRENCH FOR DENTAL IMPLANT

(76) Inventor: Cheng-Kang Yeh, Hsinchu (TW)

Correspondence Address: RABIN & Berdo, PC, 1101 14TH STREET, NW, SUITE 500, WASHINGTON, DC, 20005, US

(21) Appl. No.: 12/401,957

(22) Filed: Mar. 11, 2009

(51) Int. Cl. A61C 3/00

(52) U.S. Cl. 433/141

(57) ABSTRACT

A wrench for dental implant is provided, including a main structure, a ratchet element and a wrench arm. The main structure has a shape of long handle, and has a trench channel along the axis of handle. The ratchet element is confined inside the main structure, with the capability to move slight along the axis of the handle, and has a protruding tooth for protruding and engaging. One end of the wrench arm is engaged to the main structure, and extends beyond to outside. The main structure includes a plurality of marks on the outer surface close to the trench channel. In this manner, the wrench arm bends to leave the trench channel during the tightening operation of dental implant, the strength of exerted force can be controlled by reading the marks of the location where the wrench arm leaves the trench channel.

### FIELD OF THE INVENTION

The present invention generally relates to a wrench for dental implant, and more specifically to a wrench of small size and convenient to exert force during dental implant.

### BACKGROUND OF THE INVENTION

The wrench for tooth implant of the present invention is mainly applied to a dental implant screw driver. The dental implant screw driver is used to drive the fixture implanted to the alveolar ridge during the dental implant procedure. The wrench for dental implant is used as a tool for exerting force.

The conventional wrenches for dental implant include many different types. FIG. 1 shows a type of a conventional wrench. As shown in FIG. 1, wrench 90 includes a wrench body 91 and a wrench arm 92. Wrench body 91 includes an engage block 912 on the surface. One end of wrench arm 92 is engaged to engage block 912. In use, the segment of wrench body 91 having a tooth part 911 is placed inside the mouth, and the dentist exerts force on handle 921 of wrench arm 92. Because the size of wrench 90 is large, when rotating dental implant screw driver, engage block 912 and wrench arm 92 often touch the inner membrane of the mouth or the lips during the dental implant procedure, which is uncomfortable. It is imperative to devise a more convenient tool for dental implant procedure.

### SUMMARY OF THE INVENTION

The primary object of the present invention is to provide a convenient and small-sized wrench for dental implant. The wrench for dental implant uses the marks on different locations of the outer surface of the wrench to control the force exerted during the tightening procedure. Because a large portion of the wrench arm for exerting force is hidden inside the main structure, the wrench arm will not touch the inner tissue inside the mouth during the implant procedure so that is convenient to use.

To achieve the above object, the present invention provides a wrench for dental implant, including a main structure, a ratchet element and a wrench arm. The main structure has a shape of long handle. The main structure can be divided into use segment, connection segment and extension segment. The use segment has a matching hole and the extension segment has a trench channel. The trench channel is along the axis of handle. The ratchet element has a protruding tooth. The majority of the ratchet element is constrained and hidden inside the connection segment, but with the flexibility for retraction movement so that the protruding tooth protrudes inside the inner wall of the matching hole in normal condition, and can be retracted and hidden when necessary. One end of the wrench arm is engaged to inside of the connection segment. The arm extends through the trench channel of the extension segment and beyond to outside. The wrench arm can be slightly bended in the tightened locked condition.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a side view of a conventional wrench for dental implant;

FIG. 2 shows a schematic view of the first embodiment of the present invention;

FIG. 3 shows a cross-sectional view of the first embodiment of the present invention;

FIG. 4 shows a schematic view of the first embodiment in actual application;

FIG. 5A shows a schematic view of the present invention in wrenching state, where dental implant screw driver being represented as a cross-sectional view;

FIG. 5B shows a schematic view of the present invention in wrench arm bending condition, where dental implant screw driver being represented as a cross-sectional view;

FIG. 6 shows a cross-sectional view of the second embodiment of the present invention;

FIG. 7 shows a cross-sectional view of the third embodiment of the present invention;

FIG. 8A shows a cross-sectional view of AA side of FIG. 7; and

FIG. 8B shows a cross-sectional view of side BB of FIG. 7, without showing the spring.

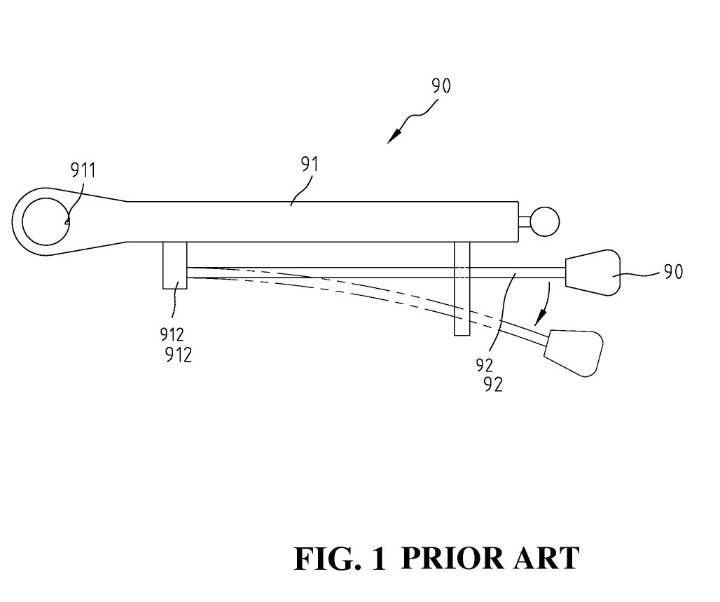

### DETAILED DESCRIPTION OF THE PREFERRED EMBODIMENTS

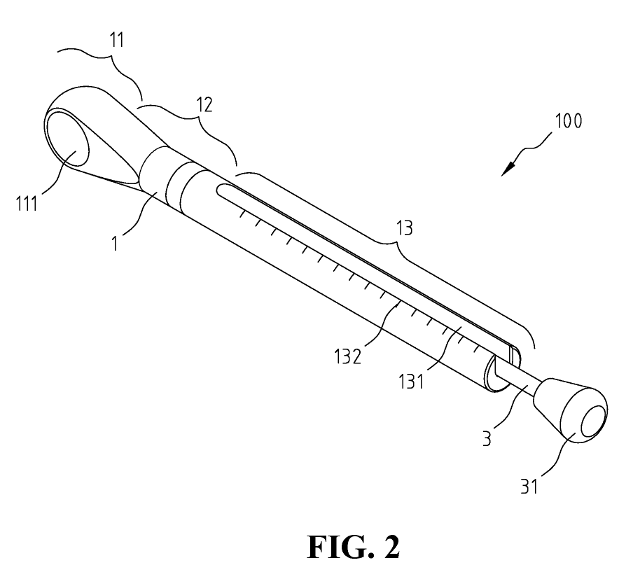

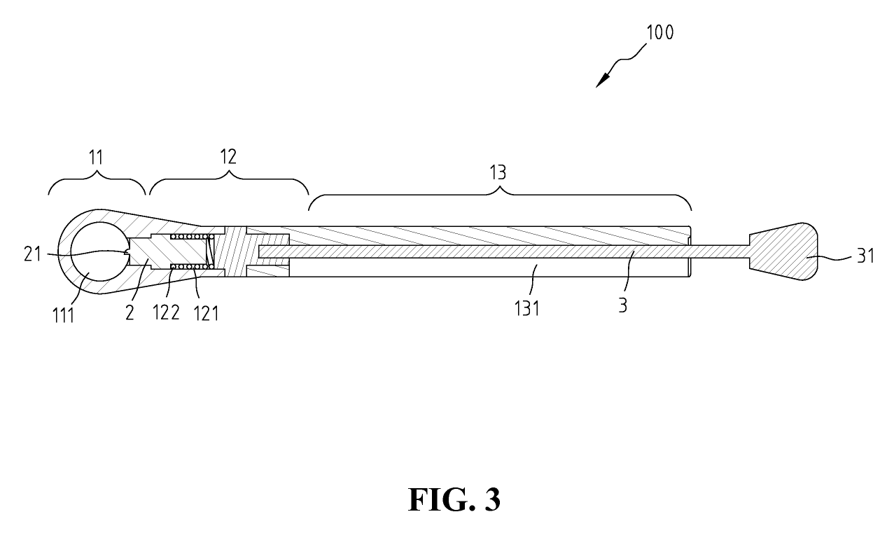

FIG. 2 and FIG. 3 show a schematic view and a cross-sectional view of the present invention respectively. A wrench 100 for dental implant of the present invention includes a main structure 1, a ratchet element 2 and a wrench arm 3.

Main structure 1 has a shape of a long handle, can be divided into three connected segments, use segment 11, connection segment 12 and extension segment 13. Use segment 11 has a ring shape, with a matching hole 111 at the center. Matching hole 111 is a round shape hole to match the dental implant screw driver. Connection segment 12 is between use segment 11 and extension segment 13. The inside of connection segment 12 includes a housing space 121 and a spring 122. Housing space 121 is for housing ratchet element 2 and spring 122 is to touch and lock ratchet element 2. A part of housing space 121 is non-circular so that the shape and the length of housing space 121 will constrain ratchet element 2 to move for a short distance along the handle direction, i.e., axis, of connection segment 12. Extension segment is a long circular column, with a trench channel 131 and a plurality of marks 132. Trench channel 131 is along the axis of the handle, and the width of trench channel is close to the outer diameter of wrench arm 3. Marks 132 are distributed on the outer surface of extension segment 13 and are located close to trench channel 131.

Ratchet element 2 includes a protruding tooth 21. The majority of ratchet element 2 is hidden inside housing space 121 of connection segment 12, with only protruding tooth 21 protruding into the inner wall of matching hole 111 of use segment 11. Protruding tooth 21 is directional. When wrench 100 rotates counterclockwise, protruding tooth 21 can temporarily be suppressed, and when wrench rotates clockwise, suppressed protruding tooth 21 can also rotate other components.

One end of wrench arm 3 is engaged to inside of connection segment 12. Wrench arm 3 extends through trench channel 131 of extension segment 13 and beyond to outside. The end of wrench arm 3 extending beyond to outside form a holding part 31. The outer diameter of wrench arm 3 is small and wrench arm 3 can bend slightly when the exerted force is too strong. In normal condition, the majority of wrench arm 3 is hidden inside trench channel 131.

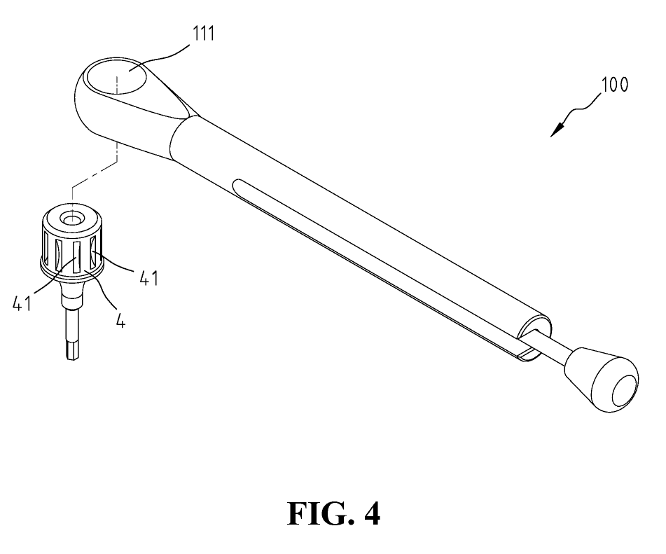

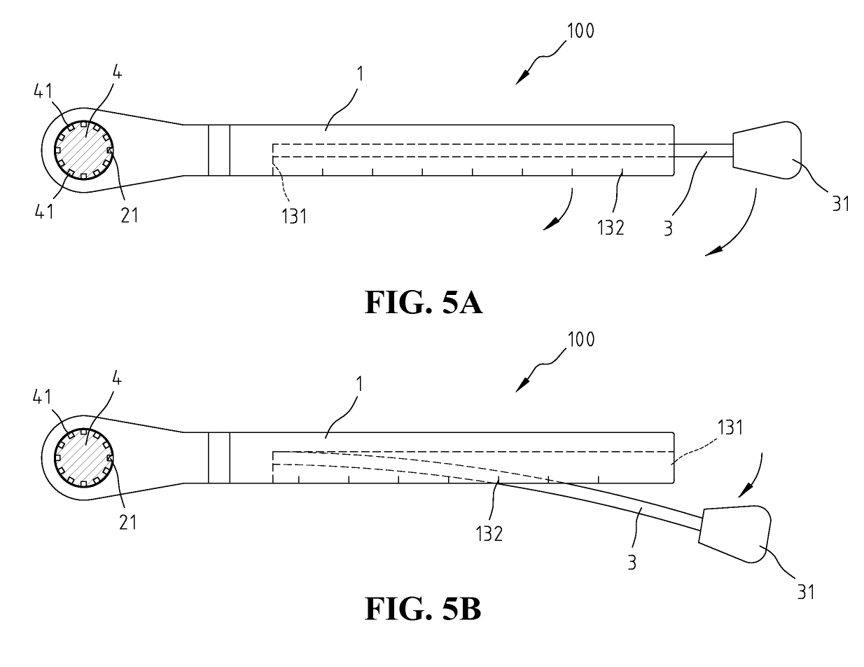

FIG. 4 shows a schematic view of the present invention in actual application. Dental implant screw driver 4 is a type commonly used at present. The circumference of dental implant screw driver 4 forms a plurality of dents. During the dental implant, dental implant screw driver 4 contacts the fixture (not shown) implanted into the alveolar ridge. When in use, wrench 100 of the present invention has matching hole 111 surrounding dental implant screw driver 4, and protruding tooth 21 engages to dent 41. As shown in FIG. 5A, in the initial stage of tightening, the force is exerted onto main structure 1 to screw the fixture into the alveolar bone. With only 1-2 screw teeth left, the force is exerted on hold part 31 of wrench arm 3. At this point, main structure will rotate synchronously, and finally, the fixture is completely screw into and touches the alveolar bone to achieve the initial tightened and lock state. At this point, the majority of wrench arm 3 is hidden inside trench channel 131. As shown in FIG. 5B, when dental implant screw driver 4 is in tightened condition, wrench arm 3 will slightly bend and partially leave trench channel 131 if the force is continuously exerted on holding part 31. To control the strength of the exerted force, mark 132 can indicate the location where wrench arm 3 leaves trench channel 131 so as to determine the exerted force for the final tightening. During the process, wrench arm 3 must reach the torque required to reach mark 132 on main structure 132.

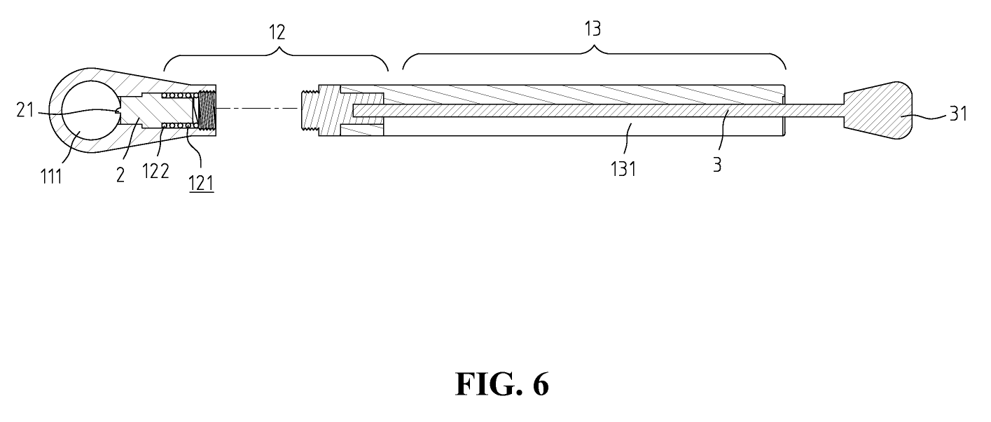

FIG. 6 shows a second embodiment of the present invention. For the ease of cleaning the interior components of connection segment 12 of main structure 1, connection segment 12 of the present embodiment can be disassembled and re-assembled with the use of screw teeth.

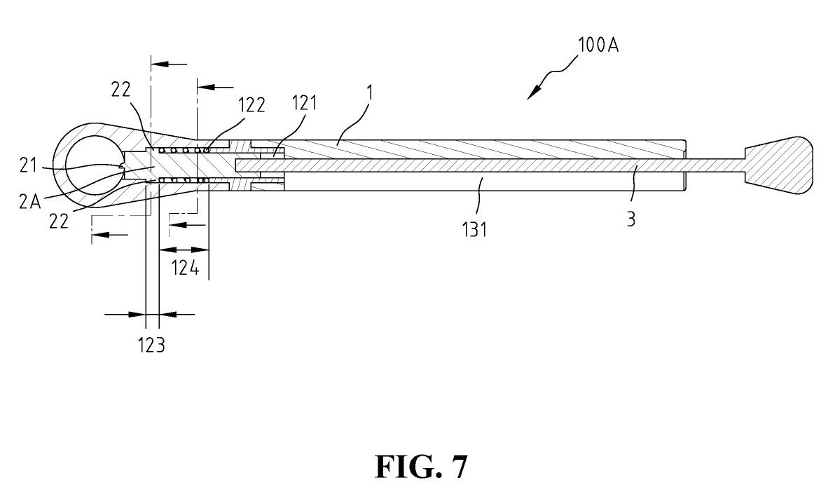

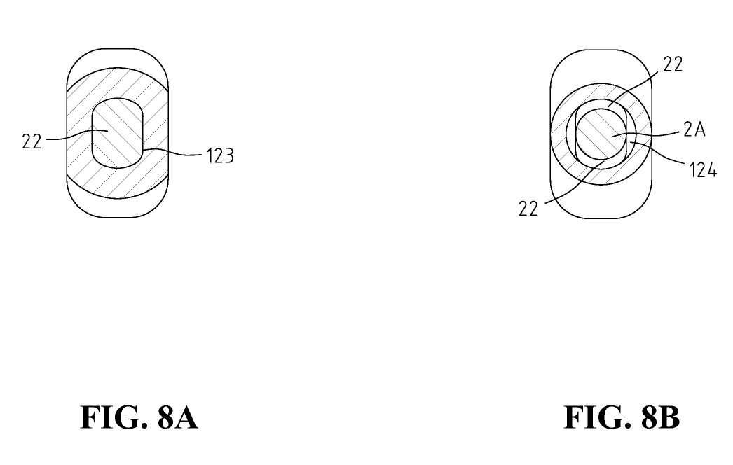

The above embodiments show that the direction of protruding tooth 21 of ratchet element 2 is fixed; hence, tightening or loosening operation is directional. For more convenient use, the present invention provides a different structure. FIG. 7 shows a third embodiment of the present invention. In the third embodiment, the direction of protruding tooth 21 of ratchet element 2 can be changed. Wrench 100A includes a main structure 1, a ratchet element 2A and a wrench arm 3. The difference between the third embodiment and the prior embodiments includes the shapes of housing space 121 and ratchet element 2A, and the linkage relation of wrench arm 3. In this embodiment, housing space 121 is connected to trench channel 131. The other end of ratchet element 2A opposite to protruding tooth 21 extends and is connected to wrench arm 3. Although ratchet element 2 is still confined to move along the axis inside housing space 121, the movement distance is longer than the previous embodiments. As shown in FIG. 7, FIG. 8A and FIG. 8B, housing space 121 can be divided into first space 123 and second space 124. The shape of first space 123 is non-circular and the shape of second space 124 is circular. Ratchet element 2 further includes a contact part 22. The shape of contact part 22 is the same as first space 123. Contact part 22 can slide inside first space 123. Contact part 22 can rotate inside second space 124.

As shown in FIG. 7, to change the direction of protruding tooth 21 of ratchet element 2A, wrench arm 3 is pulled to the right in the figure. This will displace ratchet element 2A so that contact part 22 of ratchet element 2A will completely leave the inner wall of first space 123. When contact part 22 completely enters the inner wall of second space 124, wrench arm 3 can be rotated. The rotational angle must be 180° so that the direction of protruding tooth 21 can be completely changed. After that, wrench arm 3 is released, spring 122 will make contact part 22 of ratchet element 2A enters first space 123 of housing space 121. In this manner, ratchet element 2A can be fastened. The remaining operation is the same as the first embodiment.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A wrench for dental implant, comprising:
a main structure;
a ratchet element; and
a wrench arm;
wherein said main structure having a shape of a long handle, being divided into three connected segments, i.e., a use segment, a connection segment and an extension segment, said use segment having a matching hole, extension segment having a trench channel extending along axis of said handle, outer surface of said extension segment close to said trench channel having a plurality of marks;
said ratchet element being mostly hidden inside said connection segment, with capability of short distance movement, having a protruding tooth, said protruding tooth being protruding into inner wall of said matching hole in normal condition; and
one end of said wrench arm being engaged to inside of said connection segment, said wrench arm extending through said trench channel of said extension segment and beyond to outside, said wrench arm bending slightly with strong exerted force.

2. The wrench for dental implant as claimed in claim 1, wherein said width of said trench channel is close to outer diameter of said wrench arm.

3. The wrench for dental implant as claimed in claim 1, wherein said matching hole of said use segment is round.

4. The wrench for dental implant as claimed in claim 1, wherein one end of said wrench arm is engaged and fixed to inside of said connection segment.

5. The wrench for dental implant as claimed in claim 1, wherein inside of said connection segment has a housing space and a spring, said housing space is for housing said ratchet element and said spring is to touch and lock said ratchet element, a part of said housing space is non-circular so that the shape and the length of said housing space constrains said ratchet element to move for a short distance along said handle direction, i.e., axis, of said connection segment.

6. The wrench for dental implant as claimed in claim 1, wherein inside of said connection segment has a housing space and a spring, said housing space is for housing said ratchet element and said spring is to touch and lock said ratchet element, said housing space is connected to said trench channel, other end of said ratchet element opposite to said protruding tooth extends and is connected to said wrench arm, a part of said housing space is non-circular so that said housing space constrains said ratchet element and said wrench arm to retract, move and rotate for a short distance along said handle direction, i.e., axis, of said connection segment.
